(19) United States
(12) Patent Application Publication
(10) Pub. No.: US 2008/0006575 A1
(43) Pub. Date: Jan. 10, 2008

(54) Filter Casette Consisting a Housing Surrounding a Folded Carpet with Spacers Between Parallel Opposite Filter Carpet Parts

(75) Inventors: Jan Berntsson, Kvanum (SE); Mikkael Dahlen, Lidkoping (SE); Rolf Andersson, Vara (SE)

Correspondence Address: DENNISON, SCHULTZ & MACDONALD, 1727 KING STREET, SUITE 105, ALEXANDRIA, VA, 22314, US

(73) Assignee: ABSOLENT AB, Lidkoping (SE)

(21) Appl. No.: 11/569,570

(22) PCT Filed: May 23, 2005
(86) PCT No.: PCT/SE05/00758

§ 371 Date: Jul. 18, 2007

(30) Foreign Application Priority Data
May 26, 2004 (SE) 0401330-6

(51) Int. Cl. B01D 46/12; B01D 46/52; B01D 53/18

(52) U.S. Cl. 210/493.5

(57) ABSTRACT

In a filter unit with a folded filter mat that has spacing devices between parallel opposing parts of the filter mat, the contaminants (e.g. liquids) that have been filtered out collect at the bottom of the unit. The air flowing through the unit is capable of sucking up contaminant liquids so that the air leaving the unit, rather than being clean, contains undesirable, previously filtered contaminants. The present invention reduces such additional contamination by so designing/arranging the spacing devices that they prevent additional contamination being added to the air flowing through the filter unit.

The present invention is based on a filter unit consisting of a housing surrounding a folded filter mat that has spacing devices between parallel opposing parts of the filter mat. Such a filter unit can be parallelepipedic and the opposing parts of the filter mat can simply be vertical. Contaminated air is introduced by a fan at the base of the filter unit and clean air is extracted at the upper end of the unit. During the passage of the contaminated air, contaminants are collected at the bottom of the filter unit. Some of the contaminants may be liquids. It has been shown that, at a certain speed, air can suck up and carry liquids that have collected at the bottom of the filter unit. When it exits the unit, this air contains contaminants filtered from previously cleaned air.

The present invention is designed to prevent previously collected contaminants being sucked up by subsequent air flows that are to be cleaned by the unit's filter mat.

Filter units are used to filter oil-laden air not only from lathes, milling machines, drills, grinders and hardened drilling tools but also from machines used in cold rolling, hot rolling, hot forming, die casting, wire drawing and the manufacture and machining of rubber, plastic and so on. Depending on the type of contamination, different types of filter are required. In the foregoing application areas, the air flow through the filter is large, normally between 500 and 200,000 m³ per hour. The filter should be able to withstand continuous use. This means that, for at least one year, and without stoppages for draining and cleaning, it must be able to filter air that contains oil in a spray form (usually between 0.5 and 100 mg per cubic metre of air). The filter must be self-draining. This means that the oil trapped by the filter has to be drained while the filter is still in use and with the served machinery still running. Throughout its entire service life, the filter should, when filtering emulsion aerosols and oil aerosols, have a separation efficiency of between 80 and 90 percent. The collection efficiency can be measured using instruments such as the “Dust Track TS1”. Furthermore, the filter should be washable and capable of being reused at least five times.

Provided that it can trap the contaminants in the air passing through it, the filter can be of any type whatsoever.

Fibres are a suitable material for filters. Glass fibres of less than 20 micrometres are to be preferred. Glass fibres with a fibre size in the range of 3-12 micrometres are particularly suitable. Fibrous material can be held together by needling. In this process, needles are stuck into the material, thereby pulling some of the surrounding fibres with them. These fibres take up a transversal alignment and hold the material together, even after the needles have been pulled out. As the fibres have been needled securely to each other, rather than joined using a bonding agent, the risk of auto-ignition in the oil filter is considerably reduced.

It has been observed that the spaces where the spacing devices are arranged in the filter unit provide passages for the contaminants collected at the bottom of the unit. At certain speeds, the air flowing through the unit is capable of sucking up contaminants from the bottom of the unit. It has been observed that, by adopting a particular design for the spacing devices, the air flow can be prevented from sucking up contaminants from the filter's bottom. A spacing device can be a sheet-like element that, as a rule, is vertical. Air flows through the filter mat and then along the spacing devices up to the opening at the filter unit's outlet. Together with the opposing part of the filter mat, the back of each spacing device forms a through-flow channel for the contaminants that have collected at the bottom of the filter unit. To prevent liquid being sucked up through the channels formed by the back of each sheet element and the opposing part of the filter mat, the back of the element has a surface coating that gives rise to high friction. This makes it impossible for contaminants to mix with the air flowing through the unit. The sheet-like element can also have holes so that upward flowing contaminants are transferred to the sheet-like element's front and fall down to the bottom of the unit. It is also possible to have various types of flanges on the back of the filter unit. The sheets can also have parts that, arranged one after the other, form contact surfaces touching the opposing parts of the filter mat walls. The contact parts are, as a rule, vertical. As a rule, they are arranged so that every other contact part is in contact with one of the two opposing parts of the filter mat. The interposing contact parts are in contact with the other of the two opposing parts of the filter mat. The sheet with contact parts can have a cross section that is either sinusoidal or saw-toothed. The spacing device can also be made up of a network that is so arranged as to make it impossible for contaminants to be sucked up from the unit's bottom.

Further characterising features of the present invention are given in the patent claims below. The present invention is described in greater detail with the assistance of the attached two drawings.

FIG. 1 shows a filter mat that has spacing devices and is enclosed in a housing.

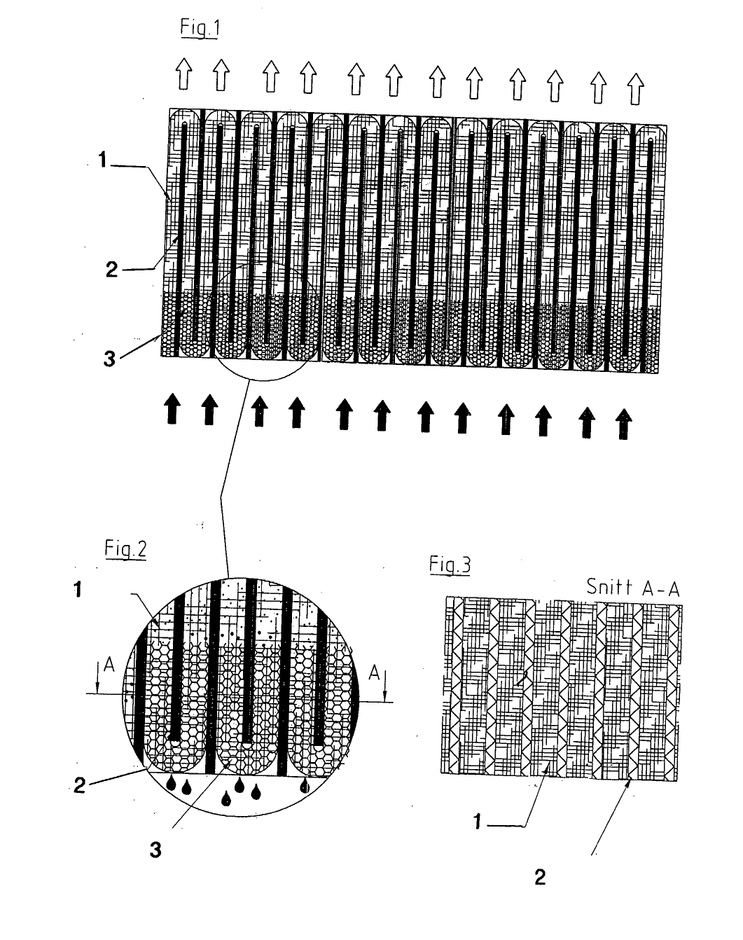

FIG. 2 shows an enlarged section of the filter shown in FIG. 1.

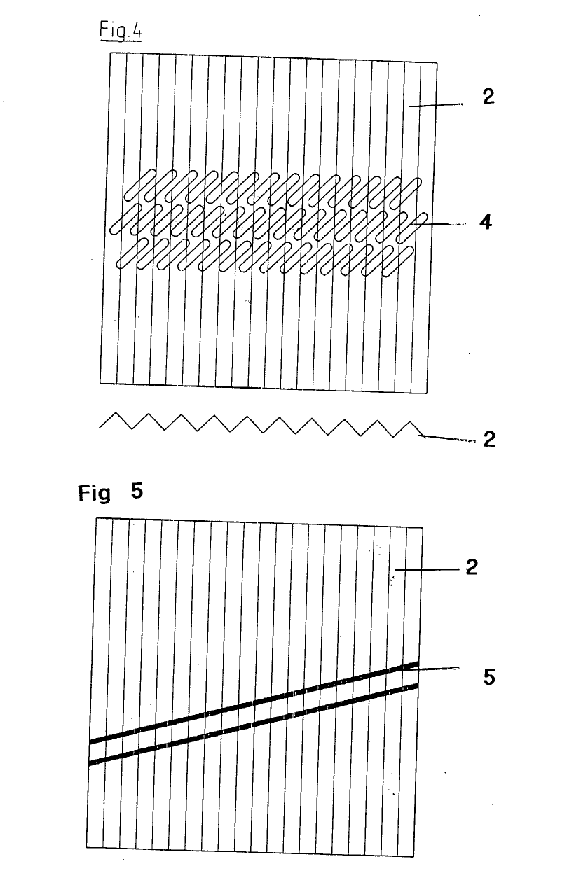

FIG. 3 shows a cross section of the area shown in FIG. 2.

FIG. 4 shows a corrugated spacing device that has been provided with holes.

FIG. 5 shows a corrugated spacing device that has been provided with outward facing flanges.

FIG. 1 shows a unit with a filter mat (1). The mat can be of the type previously described. However, it is presumably clear that, provided it is able to separate contaminants from the air that flows through it, the filter mat can be made of any suitable material whatsoever. The folded filter mat is so arranged that it always has two parts standing in opposition to each other. To maintain a certain distance between two opposing parts of the filter mat, it is necessary to use a spacing device (2). As clearly shown by FIGS. 4 and 5, this spacing device is most suitably a corrugated sheet Thus, in being filtered, air will flow along the front of the corrugated sheet and up towards the opening at the unit's outlet. FIG. 1 shows that contaminants collected by a filter mat finish up on the bottom of the filter unit. This is clearly shown at the point marked 3. The collected contaminants at the bottom of the unit are capable of being sucked up by the air flow. This takes them upwards through the air channels formed by the filter mat walls opposing the sheets (2).

If the back of each sheet is made in such a way that the surface has the maximum possible friction, this friction will prevent contaminants flowing up the channels that have the back of each spacing device as one of their sides. Instead of introducing great friction, it is also possible to have holes (4) through which the upward flowing contaminants can pass and then run back down to the bottom of the unit. These holes can also be so arranged that there is direct connection between them and the parts of the filter mat at their fronts. The contaminants are then sucked up by said pats of the filter mats. As in FIG. 5, the corrugated sheet can also be given outward facing flanges (5). These flanges prevent contaminants at the bottom of the filter unit being sucked up to the unit's outlet.

The corrugated spacer sheet can have a sinusoidal or saw-toothed cross section. It can also be of any suitable material whatsoever—metal, plastic and other materials can all be considered.

A spacing device can also be made of a blanket of threads that is so arranged as to prevent contaminants at the bottom of the filter unit being sucked up by the flow of air that is to be cleaned.

1. Filter unit comprising a housing surrounding a folded filter mat that has spacing devices between parallel opposing parts of the filter mat, the whole being characterised by each spacing device being so arranged (preferably) that liquid collected in the filter unit is prevented from moving to the unit's outlet and thereby contaminating the flow therefrom.

2. Filter unit as per patent claim 1, characterised by each spacing device having one or more surfaces that have a surface friction of a magnitude sufficient to prevent liquid being transported to the unit's outlet.

3. Filter unit as per patent claim 1, characterised by each spacing device being made of a network that is so arranged as to prevent liquid being transported to the unit's outlet.

4. Filter unit as per patent claim 1, characterised by each spacing device being made of a sheet-like unit of, for example, metal, plastic or similar.

5. Filter unit as per patent claim 1, characterised by each sheet-like element being so designed that it has a number of contact parts that, arranged one after the other, touch the opposing parts of the filter mat wall, every other contact part being in contact with one of the two opposing parts of the filter mat while the interposing contact parts are in contact with the other of the two opposing parts of the filter mat.

6. Filter unit as per patent claim 5, characterised by each sheet-like element having a sinusoidal or saw-toothed cross section.

7. Filter unit as per patent claim 5, characterised by each sheet-like element having holes allowing liquid to flow from one side of said unit to the other.

8. Filter unit as per patent claim 7, characterised by each hole being so disposed that any liquid flowing through it is absorbed by the adjacent part of the filter mat.

9. Filter unit as per patent claim 4, characterised by each sheet-like element having, at least, on one of its sides one or more outward facing flanges or flange sections that are so oriented as to prevent the transport of liquid towards the filter unit's outlet.

10. Filter unit as per patent claim 1, characterised by the filter mat being made of a fibrous material such as glass fibres that, preferably, are held together by needling.

11. Filter unit as per patent claim 10, characterised by the fibres in the fibrous material being of a size less than 20 micrometres.

12. Filter unit as per one or more of the preceding patent claims, characterised by the filter mat having a thickness of between 3 and 40 millimetres.
